(19) United States
(12) Patent Application Publication
(10) Pub. No.: US 2023/0166415 A1
(43) Pub. Date: Jun. 1, 2023

(54) BLADE WITH SKIN AND HAIR CONTROL ELEMENT

(71) Applicant: BIC Violex Single Member S.A., Anoixi (GR)

(72) Inventors: Christos GALANIS, Anoixi (GR); Christos AMPATIS, Anoixi (GR); Georgios KANAKARIS, Anoixi (GR); Charalampos SCHIZAS, Anoixi (GR)

(73) Assignee: BIC Violex Single Member S.A., Anoixi (GR)

(21) Appl. No.: 18/059,261

(22) Filed: Nov. 28, 2022

(30) Foreign Application Priority Data
Nov. 29, 2021 (EP) 21211039.9

(51) Int. Cl. B26B 21/16

(52) U.S. Cl. CPC B26B 21/165

(57) ABSTRACT

A razor cartridge comprising a first cutting member, a second cutting member and a control element. The first and second cutting members are disposed between a leading longitudinal side and a trailing longitudinal side of the razor cartridge in a shaving direction of the razor cartridge, wherein the second cutting member is disposed behind the first cutting member in the shaving direction, and wherein each cutting member faces in the shaving direction. The control element is disposed between the first cutting member and the second cutting member, wherein the control element is in contact with the second cutting member.

### CROSS REFERENCE TO RELATED APPLICATION

This application claims priority from European patent application No. EP21211039.9, filed on 29 Nov. 2021, the entire contents of which being incorporated herein by reference.

### TECHNICAL FIELD

The present disclosure relates to razor cartridges, shaving razor assemblies and methods of manufacturing a razor cartridge.

### BACKGROUND

Safety razors with multiple blades have been known for quite some time. However, there is an ongoing effort to improve the properties of such safety razors. Some razor designs are provided with multiple blades (i.e. cutting members) and with small inter-blade span (IBS) between adjacent blades to increase the shaving efficiency. However, such type of razor configuration with small IBS has the risk of cutting hairs very close or below the skin level, which could end up in trapped hairs that could lead to pseudo folliculitis barbae (PFB). In fact, when the first blade cuts a hair, the cutting process involves a skin pulling effect that slightly raises the skin at the hair follicle region. The hair is being bent toward the skin until the blade edge penetrates it to cut it. If the second blade is close enough to the first blade, it will meet the same hair at a bent status which favors a pointy hair cutting profile. Additionally, if the subsequent blades are very close located to the first one, the risk of traumatizing the lifted skin is high.

According to the literature, the time that a hair is retracted to its follicle after being pushed out during shaving action by a first blade can be as long as an eighth of a second. So if a second blade attacks the same hair at a time less than ⅛ of a second, there is a risk that the hair will be shaved closer to the skin level or even at a point lower than the skin level. To avoid this close shaving action, the second blade will have to “wait” for at least ⅛th of a second before attacking the same hair. Thus, by increasing the IBS, close shaving at a level lower to the skin can be avoided, and the more the IBS is increased, the easier it is for the user to achieve this effect. With a large IBS, the hair will have the necessary time to elastically restore at its initial more upwards position. This has the advantage to reduce the risk of cutting hairs with a sharp tip profile, thus reducing the risk of curly hairs re-entering and penetrating the skin that also leads to PFB. Additionally, a large IBS may provide enough time for the skin to reset to its original position and to minimize the risk of cutting it or irritating it by the subsequent blades. Therefore, it may be favorable to design shaving razor with large IBS between adjacent blades.

However, such type of shaving razor designs with large IBS may be unfavorable for users that have skin issues such as PFB, acne issues, uneven skin, or more generally skin sensitivity issues. The blade edge can cause a harming effect on the skin when sliding on the skin surface, thus creating irritation and/or a burning feeling. There is also provided a risk of traumatizing raised papules and pustules in case of users with e.g. acne.

It is the object of the present disclosure to provide a shaving razor with improved performance and reduced risk of skin harming.

### SUMMARY

According to a first aspect, a razor cartridge is provided. The razor cartridge comprises a first cutting member and a second cutting member disposed between a leading longitudinal side and a trailing longitudinal side of the razor cartridge in a shaving direction of the razor cartridge. The second cutting member is disposed behind the first cutting member in the shaving direction. Each cutting member faces in the shaving direction. The razor cartridge further comprises a control element disposed between the first cutting member and the second cutting member, wherein the control element is in contact with the second cutting member.

The razor cartridge as disclosed herein provides the advantage that, compared to a razor cartridge with only one cutting member, the usage of two cutting members or more increases the shaving efficiency. Further, the presence of the control element permits to support the skin during shaving, which decreases the harming effect of the cutting edges of the cutting members while sliding on the skin surface, thus minimizing the creation of irritations and/or burning feeling. The control element also permits to decrease the risk of traumatizing the raised papules and pustules, as it provides an extra safe distance from the skin and/or decreases the pressure exerted by the cutting edge on the skin surface. The control element can act as a skin and hair control element which functions will be described in more detail below.

In addition or alternatively, the control element may comprise a central portion. In addition or alternatively, the central portion may comprise a plurality of elongated apertures oriented parallel to the shaving direction.

In addition or alternatively, the control element may further comprise a front portion, wherein the front portion may be situated adjacent to and before the central portion in the shaving direction. In addition or alternatively, the front portion may be inclined downward by an angle α between 0° and 90° relative to a shaving plane.

In addition or alternatively, the control element may further comprise a rear portion, wherein the rear portion may be situated adjacent to and behind the central portion in the shaving direction. In addition or alternatively, the rear portion may be inclined downward by an angle β between 0° and 90° relative to the shaving plane.

In addition or alternatively, the control element may further comprise a hollow portion situated between the central portion and the rear portion, wherein the hollow portion may be elongated perpendicularly to the shaving direction. In addition or alternatively, the apertures of the central portion may be connected with the hollow portion.

In addition or alternatively, each cutting member may comprise a blade portion with a cutting edge, and a support portion, wherein the cutting edge may face in the shaving direction. In addition or alternatively, each support portion may be located in a separate longitudinal holding slot of the razor cartridge. In addition or alternatively, an inter-blade span (IBS) between the cutting edges of the first and the second cutting member may be more than 1,5 mm, in particular in a range of 3 to 6 mm, more particular 5,2 mm. A larger IBS may be advantageous compared to a smaller IBS, and will be described in more details below.

In addition or alternatively, the rear portion may be in contact with the second cutting member. In addition or alternatively, the inclination of the rear portion may correspond to an inclination of the blade portion of the second cutting member, such that the rear portion and the blade portion may be in planar contact with each other.

In addition or alternatively, the central portion may be parallel to the shaving plane. In addition or alternatively, the central portion may be configured to be in contact with a skin of a user during shaving.

In addition or alternatively, the rear portion may be in contact with the cutting member on a lower side of the blade portion, such that the cutting edge of the blade portion may be situated above the rear portion of the control element.

Alternatively, the rear portion may be in contact with the cutting member on an upper side of the blade portion, such that the cutting edge of the blade portion may be situated below the rear portion of the control element.

In addition or alternatively, the control element may be in contact with the second cutting member such that an exposure of the cutting edge may be neutral or positive.

In addition or alternatively, the control element may be in contact with the second cutting member such that an exposure of the cutting edge may be negative.

In addition or alternatively, the control element may be fixedly attached to the second cutting member.

In addition or alternatively, the razor cartridge may further comprise elastic spring fingers arranged in the razor cartridge and configured to support and vertically move the cutting members and/or the control element during shaving. In addition or alternatively, the control element and the second cutting member may be supported by at least one elastic spring finger.

According to a second aspect, a shaving razor assembly is provided, wherein the shaving razor assembly comprises a handle and a razor cartridge as described in this disclosure, wherein the razor cartridge is connected to the handle.

### DESCRIPTION OF THE DRAWINGS

Other characteristics will be apparent from the accompanying drawings, which form a part of this disclosure. The drawings are intended to further explain the present disclosure and to enable a person skilled in the art to practice it. However, the drawings are intended as non-limiting examples. Common reference numerals on different figures indicate like or similar features.

FIG. 1 is a perspective view of a shaving razor (e.g. a wet shaving razor), comprising a razor cartridge according to the disclosure.

FIG. 2 is a schematic cutaway side view of a razor cartridge according to the disclosure.

FIG. 3 is a top view of the razor cartridge of FIG. 2.

FIG. 4 is a schematic side view of a control element and a second cutting member.

FIG. 5 is a perspective view of the control element and the second cutting member of FIG. 4.

FIG. 6 is another perspective view of the control element and the second cutting member of FIG. 4.

FIGS. 7A, 7B and 7C are schematic side views three alternative types of cutting elements.

FIGS. 8A, 8B and 8C are respectively schematic side view of a control element and a second cutting member representing a negative exposure, a neutral exposure and a positive exposure.

FIGS. 9A and 9B are schematic side views of a control element and a second cutting member representing two negative exposures.

FIG. 10 is a schematic cutaway side view of a razor cartridge according to an alternative embodiment.

FIG. 11 is a schematic cutaway side view of a razor cartridge according to an alternative embodiment.

FIG. 12 is a schematic cutaway side view of a razor cartridge according to an alternative embodiment.

FIG. 13 is a perspective cutaway view of the razor cartridge of FIG. 12.

FIG. 14 is a schematic cutaway side view of a razor cartridge according to an alternative embodiment.

FIG. 15 is a perspective view of an alternative embodiment of a control element and second cutting member.

FIG. 16 is a top view of the control element of FIG. 15.

FIG. 17 is a top view of the control element and the second cutting member of FIG. 15.

FIG. 18 is a perspective view of an alternative embodiment of a control element and second cutting member.

FIG. 19 is a top view of the control element according to FIG. 18.

FIG. 20 is a top view of an alternative embodiment of a control element.

FIG. 21 is a top view of the control element of FIG. 20 and/or FIG. 19 and a second cutting member.

FIG. 22 is a schematic side view of an alternative embodiment of a razor cartridge with two control elements.

### DETAILED DESCRIPTION

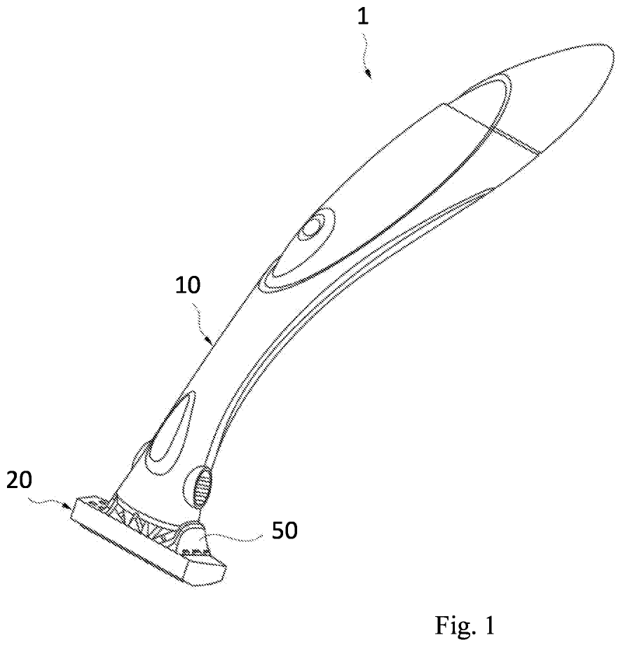

FIG. 1 is a perspective view of a shaving razor assembly 1. The shaving razor assembly 1 comprises a handle 10 and a razor cartridge 20 mounted at the distal portion of the handle 10. The mounting of the razor cartridge 20 to the handle 10 may be, as shown, pivotable via a bearing member 50, thus enabling the angle of the razor cartridge 20 against the skin of a user to vary and adapt to changes during use. The razor cartridge 20 may be releasably mounted to the handle 10 in order to be removed when the cutting edges of the blades (or cutting members) are dulled. In other examples, the razor cartridge may be releasably attached to the handle via a non-pivotable connection, integrally formed with (or permanently attached to) the handle via a non-pivotable connection, or integrally formed with (or permanently attached to) the handle via a pivotable connection. Embodiments of the razor cartridge may be discussed in detail in this disclosure.

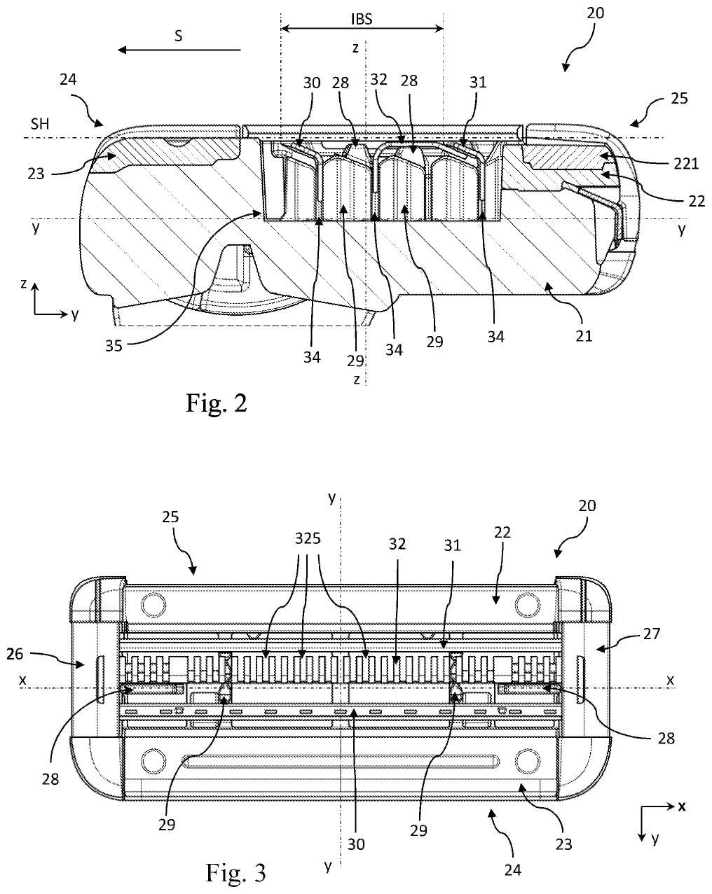

FIGS. 2 and 3 illustrate two views of a razor cartridge 20 according to the present disclosure. The razor cartridge 20 may comprise a housing 21 extending longitudinally along an axis x-x. The housing 21 may be fabricated partially or completely of synthetic materials, such as plastic, resin, or elastomers. A guard member 23 may be provided as a substantially longitudinal edge of the razor cartridge 20. In use, the guard member 23 may be the first portion of the razor cartridge 20 to contact uncut hairs, and it may thus be located at a leading longitudinal side 24 of the razor cartridge 20. The side of the razor cartridge 20 opposite to the leading longitudinal side 24 and opposite to the shaving direction S may be the trailing longitudinal side 25 of the razor cartridge 20. The trailing longitudinal side 25 may thus be the final portion of the razor cartridge 20 to contact a shaving plane SH, in use.

The direction in which the razor cartridge is moved during a shaving operation defines the shaving direction. The shaving direction is e.g. depicted in FIG. 2 using arrow S. In use, the razor cartridge contacts a shaving plane SH, and is translated across the shaving plane SH in the direction of arrow S. Typically, the shaving plane SH is defined as the tangential line intersecting the first and second skin contact points (e.g. cutting edges). More simply, the shaving plane SH may be approximated as a line between the highest points on the skin-contacting surfaced of a razor cartridge (e.g. the flat plane between the top of a guard and the top of a cap of the razor cartridge). Movement of the razor handle may cause the cutting members of the razor cartridge to be moved across the shaving plane in the shaving direction, enabling the cutting members to remove unwanted hair.

It will be noted that the terms “leading longitudinal side” and “trailing longitudinal side” are used to denote specific locations on the razor cartridge, and do not imply or require the absence or presence of a particular feature. For example, a guard member may in one example be located at the “leading longitudinal side”, and in another example a trimming blade may be located at the “trailing longitudinal side”, but it is not essential that these locations comprise such features.

The guard member may, in an example, comprise an elastomeric member. The elastomeric layer may comprise one or more fins extending longitudinally in parallel to the guard member and substantially perpendicularly to the shaving direction. One purpose of such an elastomeric layer may be, for example, to tension the skin prior to cutting.

The razor cartridge 20 may, in embodiments as e.g. shown in FIGS. 2 and 3, further comprise a cap member 22 at, or near to, the trailing longitudinal side 25. The cap member 22 may comprise a lubricating strip 221. However, the presence of a cap member is not mandatory.

As best shown in FIGS. 2 and 3, the razor cartridge 20 comprises a first cutting member 30 and a second cutting member 31 disposed between the leading longitudinal side 24 and the trailing longitudinal side 25 of the razor cartridge 20 in the shaving direction S of the razor cartridge 20. The second cutting member 31 is disposed behind the first cutting member 30 in the shaving direction S. Each cutting member 30, 31 faces in the shaving direction S. The razor cartridge 20 also comprises a control element 32 that is disposed between the first cutting member 30 and the second cutting member 31, and that is in contact with the second cutting member 31. In embodiments, the control element 32 may be attached to the second cutting member 31. By having at least two cutting members in the razor cartridge, the shaving efficiency may be increased compared to a razor cartridge with one cutting member with regard to PFB. The control element 32 may cover partially or totally the gap between the first cutting member 30 and second cutting member 31, thus providing a support to the skin during shaving and decreasing the risk of harming or injuring the skin and/or traumatizing raised papules and pustules.

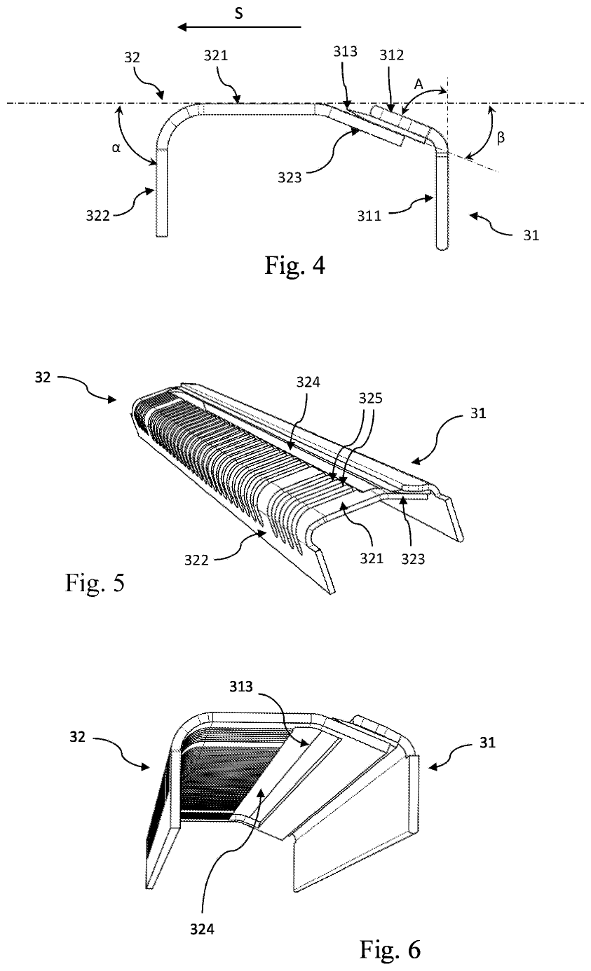

As shown in FIGS. 4 to 6, the control element 32 may comprise a central portion 321, wherein the central portion 321 may comprise a plurality of elongated apertures 325 oriented parallel to the shaving direction S. The control element 32 may also comprise a front portion 322 situated adjacent to and before the central portion 321 in the shaving direction S, a rear portion 323 situated adjacent to and behind the central portion 321 in the shaving direction S, and/or a hollow portion 324 situated between the central portion 321 and the rear portion 323. The control element will be discussed in detail subsequently.

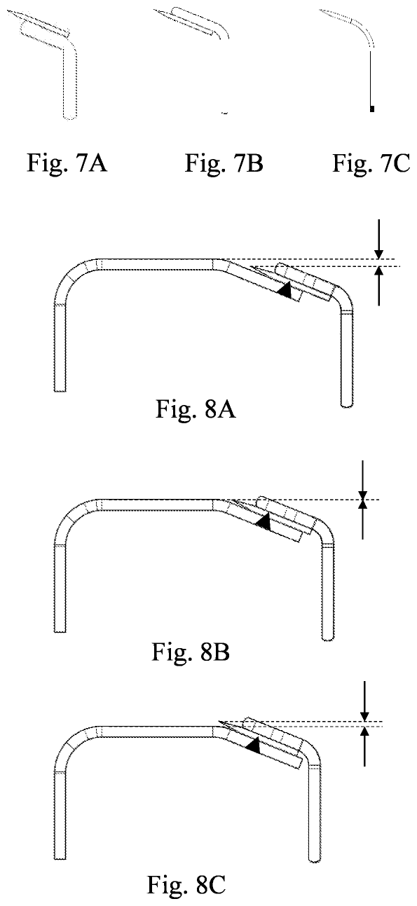

Each cutting member 31 (applies also for cutting member 30, but for ease, reference is made to the cutting member 31) may comprise a blade portion 312 with a cutting edge 313, and a support portion 311 (see e.g. FIG. 4). In embodiments, the blade portion may comprise a blade fixedly attached to the blade portion. Herein, the cutting edge may be the edge of the blade. In embodiments, the blade may be attached above the blade portion of the cutting member (see FIG. 7A) and in other embodiments, the blade may be attached below the blade portion (see FIG. 7B). The blade portion and the support portion may be integrally formed. In other embodiments, the blade may be integrally formed with the blade portion, such that the cutting edge may directly be the edge of the blade portion. Additionally, the blade portion may be integrally formed with the support portion such that the whole cutting member may integrally formed as one part (see FIG. 7C). In still other embodiments not shown, the blade portion and the support portion may be assembled parts.

The blade portion of the cutting member may be inclined by an angle A relative to the longitudinal axis of the support portion (see FIG. 4). In an example, A is an acute angle, preferably between 60 and 75 degrees, more preferably between 68 degrees and 70 degrees. Each cutting member 30, 31 may be inserted in the razor cartridge 20 such that its cutting edge faces in the shaving direction S.

Referring back to FIG. 2, each support portion of the cutting members 30, 31 may be located in a separate longitudinal holding slot 34 of the razor cartridge 20. The holding slots 34 are located in a receiving section 35 of the housing 21. Each holding slot 34 is configured to accept and retain part or all of the support portion of the cutting members 30, 31. The holdings slots 34 are arranged to each other such that the cutting members 30, 31 may be positioned parallel to each other within the razor cartridge 20. In some embodiments, the cutting members 30, 31 may be vertically movable within the holding slots 34. The term “vertically” corresponds to the direction perpendicular to the shaving plane, i.e. along the z-z axis (see FIG. 2). In other embodiments, the cutting members may be non-movably arranged within the holding slots. In still other embodiments, the razor cartridge may comprise a combination of movably and non-movably arranged cutting members. It is to be noted that at least as many holding slots are provided in the receiving section of the housing as there are cutting member support portions.

Further, the cutting members 30, 31 may be arranged in the razor cartridge 20 such that the inter-blade span between the cutting edges of the first and the second cutting members 30, 31 is more than 1,5 mm, in particular in a range of 3 to 6 mm, more particular 5,2 mm. The inter-blade span (IBS) is defined as the spacing between two adjacent cutting edges (see FIG. 2). Compared to small IBS that generally have spacings below 1,5 mm, the IBS of the present disclosure is rather large. The advantage of providing a control element covering all or part of the IBS is that the risk of traumatizing the raised papules and pustules may be decreased, as an extra safe distance between the cutting edge and the skin may be provided. Additionally, the presence of the control element has the advantage to decrease the pressure that the cutting edge exerts on the skin surface during shaving.

In FIGS. 4 to 6, the elongated apertures 325 of the central portion 321 may extend through the central portion 321, and even partially (or totally) into the front portion 322. The apertures 325 may all have the same width and length. With some exceptions, the distance between two apertures may be constant over the length of the control element, wherein the “length” is to be understood as being the longitudinal dimension along the x-x axis. In other embodiments, the apertures may not extend into the front portion, but may only extend on the central portion to a certain distance of the edge of the central portion facing the hollow portion; the apertures may have different widths and/or lengths; and/or the spacings between the apertures may be constant over the length of the control element or vary, this in a random or pre-determined manner. The central portion 321 of the control element 32 may have the form of e.g. a comb oriented against the shaving direction S. In preferred embodiments, the width of an aperture may be in a range of 0,3 to 2 mm, or 0,3 mm to 1 mm, or 1 mm to 2 mm, or 0,4 mm to 0,8 mm, or 0,4 mm to 0,6 mm, or 0,5 mm to 0,8 mm, or 0,6 mm. In other embodiments, the apertures may not extend to the front portion of the control element.

In other embodiments, the central portion of the control element may not comprise any elongated aperture, but rather be a full material portion. The full material portion may have any form that is advantageous during shaving operation for example for the skin and/or the hair management. The surface of the central portion in contact with the skin may be flat, wavy, with or without pattern, and/or others. The central portion may extend parallel to the shaving plane and/or may comprise areas that extend to a certain extend from the shaving plane (in positive and/or negative direction). In still other embodiments, the central portion of the control element may comprise apertures in any equal or different forms (e.g. round, elongated, geometrical, wavy, random, and others), having any equal or different dimensions, and/or extending in any longitudinal (x-x axis) and/or transversal (y-y axis) direction of the razor cartridge. The rear edge of the central portion adjacent to the hollow portion may also have any form, as e.g. straight, parallel to the longitudinal direction (i.e. x-x axis), inclined to the longitudinal direction, wavy, in sawtooth form, or any other form that could provide an advantage during shaving operation. In embodiments, the apertures may extend throughout the material thickness of the central portion. In other embodiments, the apertures may be configured as blind apertures, meaning that the apertures may only form a recess in the surface of the central portion that is in contact with the skin of the user. In still other embodiments, the apertures may be a combination of throughout holes and recesses.

In embodiments, the central portion 321 of the control element 32 may be parallel to the shaving plane SH (see FIG. 2), and/or may be configured to be in contact with the skin of the user during shaving. As, in particular for razor cartridges with large IBS, the risk to harm the skin of the user is higher than for razor cartridges with small IBS, this provides the advantage that the skin may be supported by the control element during shaving. The control element may provide a quick “ironing effect” to the skin before the second cutting member, thus reducing the risk of cutting or irritating the skin. Additionally, the apertures on the control element will allow hairs to be at a raised position before the second cutting member, enabling a more efficient and with less pull cutting effect. In fact, as shown in e.g. FIGS. 3, 5 and 6, the apertures 325 of the central portion 321 may be connected with the hollow portion 324. The hollow portion 324 may be elongated perpendicularly to the shaving direction S (i.e. along the x-x axis) to provide enough space for the hairs to be cut. Further, the hollow portion 324 may be adjacent to the cutting edge 313 of the second cutting member 31.

The central portion of the control element may act as a skin and hair control element. The surface of the central portion in contact with the skin during shaving may particularly have a skin control effect and/or function. In particular the central portion of the control element may provide the advantage to decrease the harming effect of the cutting edge of the cutting member sliding on the skin surface, thus creating irritation and/or burning feeling. As explained above, the central portion of the control element may support the skin during a shaving operation, to avoid that uneven areas of the skin “release” in the spacing between the first and the second cutting member and get harmed by the cutting edge of the second cutting member. Therefore, the skin control portion permits to maintain a relatively flat skin surface. The skin control portion may have shape being flat, wavy, convex, concave or others, or any combination thereof. The skin engaging surface of the control element may further comprise a lubricating coating, such as e.g. PTFE, which may decrease the friction of the razor cartridge with the skin during shaving. The apertures (or the openings of the comb-like structure) of the central portion may have a hair control effect and/or function. In particular, the apertures may permit hairs to recover a raised position after having been in contact with a first element of the razor cartridge (the cutting edge of the first cutting member, or even a guard member or other contact element) before facing the cutting edge of the second cutting member. The apertures may therefore be, without interruption, connected with the longitudinal hollow portion (which can also be seen as a longitudinal aperture). The width of the hollow portion measured in the y-y axis (e.g. as a projection in the shaving plane of the distance between the central edge of the central portion and the front edge of the rear portion of the control element) may be at least 0,2 mm, in particular at least 0,3 mm, more particularly at least 0,5 mm greater than the width of the respective skin gap measured in the y-y axis (values of the skin gap are disclosed subsequently).

As can be seen in e.g. FIGS. 3, 5 and 6, the hollow portion 324 may be an aperture between the central portion 321 and the rear portion 323 of the control element 32, wherein side portions of the central portion 321 and side portions of the rear portion 323 are still connected. In embodiments, the hollow portion 324 may be a plurality of apertures (or slots) extending longitudinally between the central portion 321 and the rear portion 323, as will be shown further below. The hollow portion may have a closed form but may also, in some examples, be open. The hair control portion, i.e. the comb-like elements, may have a surface for improving the aesthetic appeal of the razor, by being e.g. colored and/or including any graphic features. Any other portion of the control element may be provided with different colors and/or graphic feature.

Seen from a different perspective, the hollow portion may be part of the central and/or the rear portion of the control element. Herein, the hollow portion may be a cutout of the central portion and/or the rear portion of the control element. In embodiments, the hollow portion may extend partially through the central portion and/or the rear portion. Any forms, dimensions, and other characteristics of the hollow portion as defined (even the alternatives) previously may apply similarly.

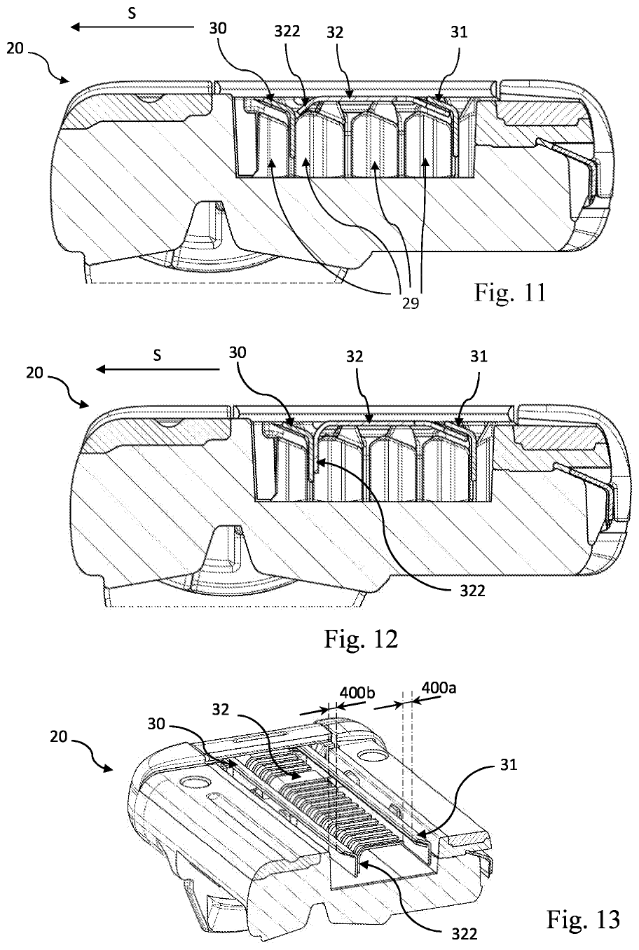

As depicted in FIG. 4 and visible in e.g. FIGS. 2, 5 and 6, the front portion 322 of the control element 32 may be inclined downward by an angle α of 90° relative to the shaving plane SH. The front portion 322 may be long enough to be at least partially inserted in a separate free holding slot 34 in the housing 21 of the razor cartridge 20 (see FIG. 2). “Free” means not already receiving the support portion of a cutting member. The holding slot receiving the front portion may be directly adjacent to the holding slot receiving the support portion of the second cutting member or, as shown in e.g. FIG. 2, be a free holding slot 34 that is more far away, leaving at least one free holding slot 34 in between the holding slot 34 of the support portion 311 of the second cutting member 31 and the holding slot 34 of the front portion 322 of the control element 32. However, in embodiments, the front portion may be inclined downward by an angle α between 0° and 90° relative to the shaving plane. In an example, the angle α may be 0° (i.e. no angled front portion). In another example wherein the angle α may be more than 0°, the front portion may be connected with the central portion through an intermediate bent portion, which would provide a gentle interaction of the control element with the skin of the user. In some embodiments, the front portion may not be inserted in a holding slot of the housing, but may, as for example shown in e.g. FIG. 11, extend at an angle α lower than 90° (e.g. between 40° and 50°). In this example, the length of the front portion 32 may be reduced in length, such that the front portion 322 does not get in contact with the first cutting member 30. In this example, the front portion 322 may further be supported by a cutting member support 29 extending vertically within the receiving section 35 of the razor cartridge 20. The cutting member support may be, for example, the cutting member support adjacent to the holding slot of the preceding cutting member, or any other cutting member support between the first and the second cutting member. It is to be understood that the term “downward” refers to the direction perpendicular to the shaving plane and oriented along an axis y toward the body of the razor cartridge. In contrast, “upward” refers to the direction perpendicular to the shaving plane and oriented along the axis y away from the body of the razor cartridge, i.e. opposite to the “downward” direction.

As depicted in FIG. 4 and also visible in e.g. FIGS. 2, 5 and 6, the rear portion 323 of the control element 32 may be inclined downward by an angle β of about 20° relative to the shaving plane SH. However, in embodiments, the rear portion may be inclined downward by an angle β between 0° and 90° relative to the shaving plane, in particular between 15 and 30°, more particular between 20 and 22°. As shown, the rear portion 323 may be in contact with the second cutting member 32. In embodiments, the inclination of the rear portion 323 may correspond to the inclination of the blade portion 312 of the second cutting member 31, such that the rear portion 323 and the blade portion 312 may be in planar contact with each other. A planar contact may facilitate a permanent contact between the two surfaces vie e.g. welding or adhesive bonding. In other examples, the contact between the rear portion of the control element and the second cutting member may not be planar. To assure a constant shaving effect of the second cutting member, the control element needs to always be at the same vertical distance from the cutting edge of the cutting member. This is ideally assured when the control element is constantly in contact with the second cutting member. Additionally, the second cutting member can be in contact with (or even attached to) the control element in various alternative locations that enable local cutting edge exposure, being neutral, positive or negative. This will be discussed in more detail below.

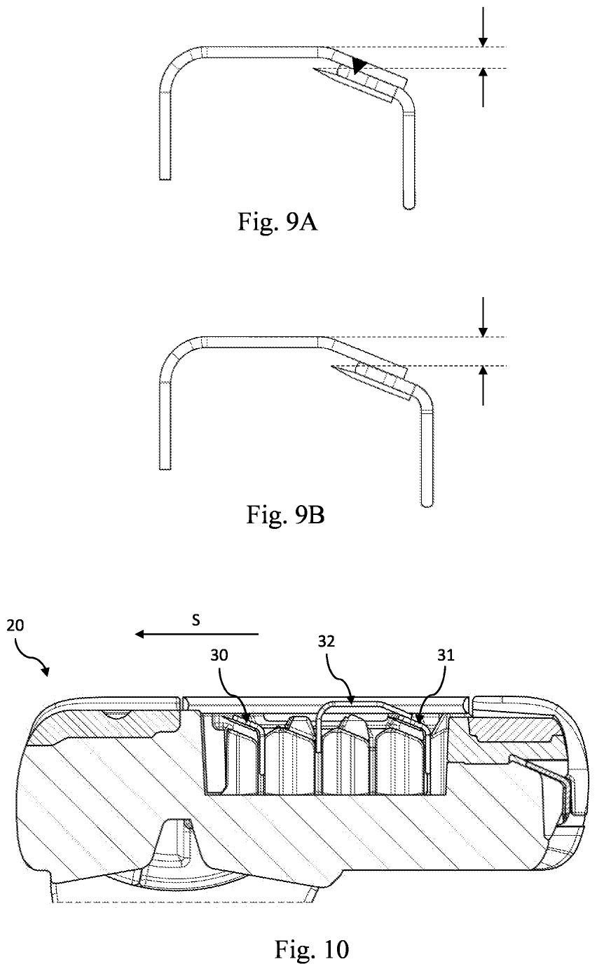

In embodiments, the control element may be attached to the second cutting member. In embodiments, the control element may be fixedly attached to the second cutting member. As for example depicted in FIGS. 8A to 8C and 9A, the rear portion 323 of the control element 32 may be fixedly attached to the second cutting member 31. The permanent attachment (i.e. fix attachment) may be assured by welding (e.g. spot welding), gluing, mechanical joint (e.g. rivet) or any other permanent means or attachment of the rear portion of the control element to e.g. the blade portion of the cutting member. In FIGS. 8A to 8C and 9A, triangles may illustrate a fix attachment, such as e.g. spot welding between the rear portion of the control element and the blade portion (with or without blade) of the second cutting member. The location of the fix attachment is such that a good resistance of the attachment is provided toward external forces on the assembly of control element and second cutting member. As best shown in FIGS. 8A to 8C, the location (i.e. distance from the relative edges of the rear portion and blade portion) of the attachment (e.g. spot welding) may vary depending on the need (e.g. exposure of the cutting edge, relative position of the control element vs the second cutting member), available space, materials, others and any combination thereof. The permanent attachment can be done on individual or several spots or surfaces, or on the complete contact surface or length of the rear portion and the cutting member. The permanent attachment may impact only the surface, or part, or all the thickness of the concerned rear portion and portion (with or without separate blade) of the cutting member. The location of the attachment may be in any contact point or surface between the control element and the cutting member; in particular in any contact point or surface between the rear portion of the cutting element and the blade portion (e.g. with or without blade, directly with the blade or with the blade portion, only with the blade portion). In use, when the cutting edge of the second cutting member is dulled, both the second cutting member and the control element may be exchanged. In case of movable cutting members, the control element can move along with the cutting member (drag it down) during shaving and interaction with the skin terrain. This dependent movement will enable better safety with less irritation and nicks & cuts. The user can apply relevantly greater vertical force on the skin with the razor without risking injuries. This configuration may be desired when the control element is situated below the second cutting member, but also when the control element is situated above the second cutting member, as will be discussed in detail below. In other embodiment, the control element may be removably attached to the second cutting element. The removable attachment may be performed via non-permanent means. The control element and the second cutting element may be detachable by mechanical, thermal or chemical action. This may have the advantage that the control element may be reused when the second cutting member is exchanged when the cutting edge is dulled. The fix or removable attachment of the control element to the second cutting member has been described with reference to the example embodiments of FIGS. 8A to 8C and 9A but may apply without restriction to any embodiment disclosed herein.

In embodiments, the permanent contact may be a constant pressure contact between the control element and the second cutting member. This can be assured by elastic spring fingers 28 arranged in the receiving section 35 of the housing 21, (see FIGS. 2 and 3), such that the control element 32 and the second cutting member 31 are always in contact, even (and particularly) when the second cutting member 31 and the control element 32 are vertically movably arranged in the razor cartridge 20. This configuration may be desired when the control element 32 is situated above the second cutting member 31, as will be discussed in detail below.

In embodiments as depicted in e.g. FIGS. 2 and 4 to 6, the rear portion 323 of the control element 32 may be in contact with the second cutting member 31 on a lower side of the blade portion 312, such that the cutting edge 313 of the blade portion 312 is situated above the rear portion 323 of the control element 32. When the rear portion is below (i.e. underneath) the cutting member, it needs to be attached with the cutting member via a permanent means such as welding, gluing or others. Thus, the control element can move along with the cutting member during shaving and interaction with the skin terrain. The relative position of the cutting edge of the cutting member vs. the shaving plane (i.e., for example, the upper surface of the central portion of the control element) may be chosen such that an exposure of the cutting edge may be positive, neutral or negative. In other words, the control element 32 may be in contact with the second cutting member 31 such that an exposure of the cutting edge 313 may be positive, neutral or negative. FIGS. 8A to 8C illustrate the three possible exposures when the rear portion 323 of the control element 32 is situated below the cutting member 31. The exposure of a cutting edge is the distance of the cutting edge from the shaving plane. FIG. 8A illustrates a negative exposure, wherein the cutting edge 313 of the cutting member 31 is below the upper surface of the control element 32 (and/or upper surface of the central portion of the control element) in the direction perpendicular to the shaving plane (or upper surface of the control element 32). FIG. 8B illustrates a neutral exposure, wherein the cutting edge 313 is at the same height than the upper surface of the control element 32 (and/or upper surface of the central portion of the control element) in the direction perpendicular to the shaving plane (or upper surface of the control element 32). FIG. 8C illustrates a negative exposure, wherein the cutting edge 313 is above the upper surface of the control element 32 (and/or upper surface of the central portion of the control element) in the direction perpendicular to the shaving plane (or upper surface of the control element 32). In FIGS. 8A to 8C, the upper surface of the control element 32 may be congruent with the shaving plane. In other examples, the shaving plane may not be congruent with the shaving plane. A positive exposure can be in a range of 0 mm to 0,1 mm, or 0,01 mm to 0,05 mm, or 0,05 mm to 0,1 mm, or 0,03 mm, or 0,05 mm. A negative exposure can be in a range of 0 mm to −0,5 mm, or −0,05 mm to −0,15 mm, or −0,15 mm to −0,3 mm, or 0 mm to −0,1 mm, or −0,1 mm to −0,2 mm, or −0,06 mm, or −0,1 mm. A negative exposure may have a trimming effect. In fact, due to the negative exposure, the hair is not cut at the edge of the skin, but at a distance equal to the value of the exposure. The triangles in FIGS. 8A to 8C shall illustrate exemplary locations of welding spots in case the control element 32 is fixedly attached by welding to the second cutting member 31. These examples should not be limiting and only show examples of possible fixation.

In other embodiments as depicted in FIGS. 9A and 9B, the rear portion 323 of the control element 32 may be in contact with the second cutting member 31 on an upper side of the blade portion 312, such that the cutting edge 313 of the blade portion 312 may be situated below the rear portion 323 of the control element 32. When the rear portion is above (i.e. over) the cutting member, it may but also may not be attached with the cutting member via a permanent means such as welding or gluing. In case of no permanent means, the control element and the cutting member may be in contact due to pressure from elastic spring fingers, as explained above. The aspect of elastic spring fingers will be discussed in detail subsequently. The control element 32 may be in contact with the second cutting member 31 such that an exposure of the cutting edge 313 is negative. Particularly, when the control element is above the cutting member, the exposure is compulsory negative. As best shown in FIGS. 9A and 9B, the relative position of the control element 32 above the cutting member 31 may determine the level of negative exposure. In fact, the cutting edge 313 of the second cutting member 31 can be located close to the lower surface of the control element 32 (and/or lower surface of the central portion of the control element), as illustrated in FIG. 9A, to have a narrow negative exposure, or the cutting edge 313 of the second cutting member 31 can be located more far away from the lower surface of the control element 32 (and/or lower surface of the central portion of the control element), as illustrated in FIG. 9B, to have a large negative exposure. The negative exposure can enable a trimming effect, wherein the level of trimming effect can be pre-determined and set during manufacturing of the razor cartridge, depending on the relative location of the control element to the cutting edge of the cutting member. The triangle form in FIG. 9A shall illustrate an exemplary location of a welding spot in case the control element 32 is fixedly attached by welding to the second cutting member 31. This example should not be limiting and only shows an example of a possible fixation.

As already mentioned before, the razor cartridge 20 may further comprise elastic spring fingers 28 arranged in the razor cartridge 20 and configured to support and vertically move the cutting members 30, 31 and/or the control element 32 during shaving. The elastic spring fingers may be resilient fingers located in the receiving section of the housing, generally extending transversally and upwardly from the side edges of the housing of the razor cartridge, and configured to support the cutting members from their lower side. During shaving, as the user applies a vertical pressure on the skin with the razor, the elastic spring fingers may permit a vertical movement of the cutting members downward such that skin injuries may be avoided. When the vertical pressure is released, the spring fingers may permit the cutting members to get back into their original position. During this vertical movement, the cutting members may slide in the holding slots of the housing. As shown for example in FIG. 2, each cutting member 30, 31 may be supported by at least one pair of spring fingers 28, wherein one spring finger of the pair supports the cutting member at one longitudinal end and the other spring finger of the pair supports the cutting member on the other longitudinal side. The spring fingers are always in contact with the cutting member, ideally on the lower side of the blade portion of the cutting members. In other embodiments, other spring elements may support the cutting members and allow a vertical movement of those. The location of the spring elements and the contact point between the spring elements and the cutting members may be different. The control element 32 and the second cutting member 31 may be supported by at least one elastic spring finger 28. Further, the control element 32 and the second cutting member 31 may be supported by at least one pair of elastic spring fingers 28. In some embodiments, only the cutting members may be supported by elastic spring fingers, and the control element may be moved with the second cutting member as the second cutting member moves. In some embodiments, the control element may be supported by its own pair of elastic spring fingers. In some examples, only one pair of elastic spring fingers may be sufficient to vertically guide the control element together with the second cutting member. In some examples, two or more pairs of elastic springers may support the control element. In the case that the control element 32 is situated above the second cutting member 31 and not fixedly attached to the second cutting member 31, as shown in FIG. 10, one pair of spring fingers 28 may be in contact with the second cutting member 31, wherein the vertical movement of the control element 32 that may guide the second cutting member 31 downwards and the effect of the spring finger 28 on the second cutting member 31 by guide the control element 32 upwards. In other examples, the pair of spring fingers may be in contact with the control element instead of the second cutting, and/or the control element and the second cutting member may each be supported by at least one pair of spring fingers.

One advantage of having the control element being in contact with at least the second cutting member is, that during a shaving operation, the control element may move along with the second cutting member. The elastic support provided by the elastic spring fingers may further enhance this simultaneous movement, which provides an excellent adaptability of the whole cutting system on the skin surface terrain.

As already described, the cutting members and/or the control element may be movably arranged in the holding slots, wherein a vertical movement in the direction of the z-z-axis may be provided. Preferably, the cutting members and/or the control element do not rotate within the holding slots. In particular, the cutting members and/or the control element may not rotate around an axis parallel to the x-x axis. In some embodiments, as explained herein, the cutting members and/or the control element may be subjected to a translation movement in the vertical direction (i.e. along the z-z axis). The cutting members and/or the control element may also translate to a certain extend in the longitudinal direction (i.e. along the x-x axis) within the holding slots. The movements of the cutting members and the control element may be combined, when e.g. the control element is attached to the second cutting member (or even only through contact of the control element with the second cutting member), or separated from each other.

In an alternative embodiment, part of the control element may be arranged in a relatively fix manner in the housing and the rest of the control element may elastically bend along with the movement of the cutting member during shaving operation. The advantage herein is that the fixed part may absorb more skin pressure, making the cutting work of the second cutting member even safer, while providing and allowing the movability of the second cutting member.

As for example shown in FIG. 13, a skin gap 400a may be formed between the central portion of the control element and the second cutting member, in particular between the rear edge of the central portion and the cutting edge of the second cutting member. The length of the skin gap may be measured parallel to the shaving plane. As depicted, another skin gap 400b of the same or a different length may be formed between the edge of the guard member and the cutting edge of the first cutting member. Additional skin gaps may be present. A skin gap may provide an area in which the skin of the user is not supported. In some examples, the skin gap may at least partially cover the hollow portion of the control element. The skin gap may provide space for the hairs to be cut. In some aspects, the width of the skin gap measured in the y-y axis (e.g. as a projection in the shaving plane) may be in a range of 0 mm to 1,5 mm, in particular in a range of 0,2 mm to 1 mm, more particularly in a range of 0,5 mm to 1 mm, more particularly in a range of 0,5 mm to 0,8 mm, even more particularly 0,8 mm.

The razor cartridge 20 as shown in FIGS. 2 and 3 may further comprise a first retainer 26 and a second retainer 27, both configured to hold the cutting members 30, 31 and/or the control element 32 within the housing 21 in a vertical direction (i.e. in the z-z axis). The retainers 26, 27 may act as vertical stop elements for the cutting members 30, 31 and/or the control element 32 when those components move vertically within the housing 21 as a result of a shaving operation. The first retainer 26 and second retainer 27 may comprise, for example, plastic, an elastomer, or a metal material and furthermore may be of a different shape to that illustrated. In some embodiments, the control element 32 may be partially located below the retainers 26, 27. In other embodiments not shown, the control element may further comprise side portions situated on both longitudinal edges of the control element and configured to abut against a lower side of the respective retainer and act as stop elements toward vertical movement. Alternatively, the cutting members and/or control element may be retained in the housing of the razor cartridge aluminum clips, plastic covers, or other components attached to the housing.

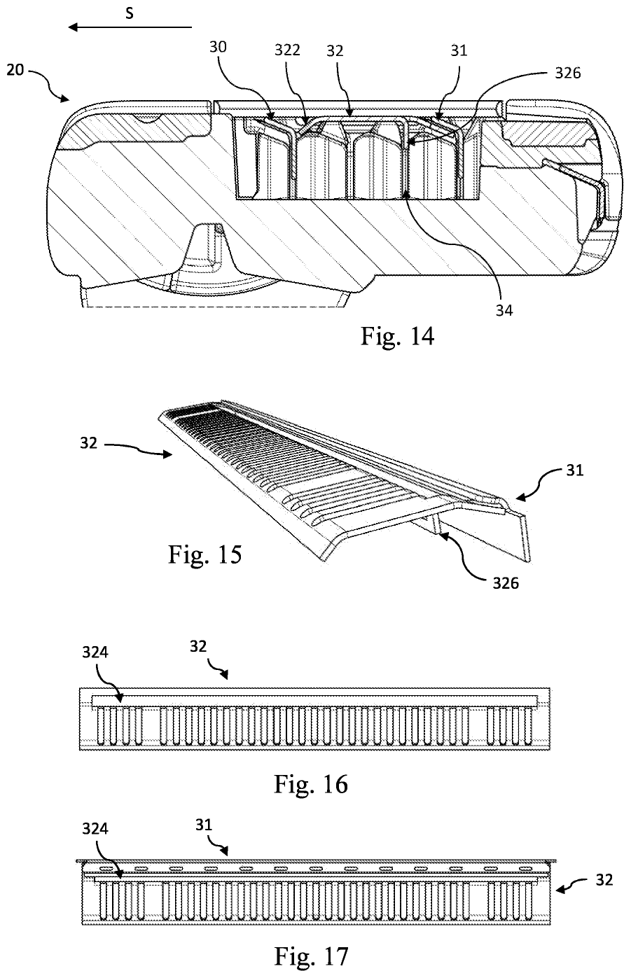

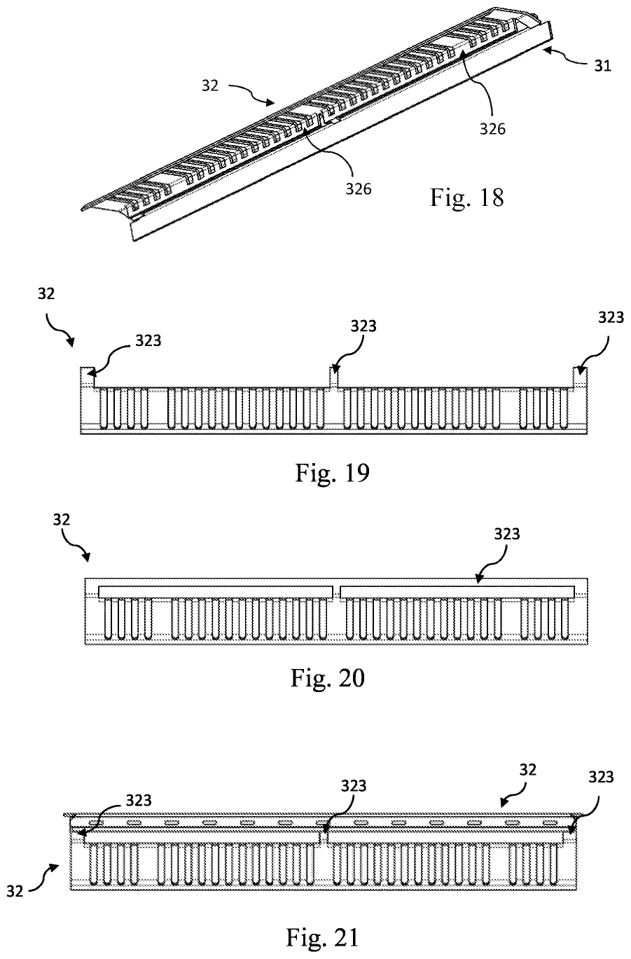

In an embodiment as shown in FIGS. 14 and 15, the control element 32 may further comprise a reinforcing portion 326 extending from the central portion 321 toward the hollow portion 324, and wherein the reinforcing portion 326 is bent vertically downward such as to be arranged in a separate holding slot 34 of the razor cartridge 20. In the embodiment shown, the front portion 322 may be reduced in length and the inclination of the front portion 322 may be less than 90°, such that the front portion 322 is not inserted in a holding slot 34 of the housing 21. In other embodiments, the reinforcing portion may be additionally to the front portion bent at 90° and inserted in a separated holding slot. The reinforcing portion may then be inserted in a holding slot situated closer to the holding slot receiving the support portion of the second cutting member. The holding slot receiving the reinforcing portion may be directly adjacent to the holding slot receiving the support portion of the second cutting member or may be more far away, leaving at least one free holding slot in between. In embodiments, the reinforcing element 326 may extend along the longitudinal length of the control element 32 as one element (see FIG. 15). In other embodiments, the reinforcing element 326 may be divided in several reinforcing elements 326 arranged side by side along the longitudinal length of the control element 32 (see FIG. 18).

In an embodiment as shown in FIG. 12, the control element 32 may be in contact with the first cutting member 30. The front portion 322 of the control element 32 may be in contact with the support portion of the first cutting member 30, and/or the control element 32 may be simultaneously in contact with the second cutting member 31. The front portion 322 and the support portion of the first cutting member 30 may be both inserted within one holding slot 34. In an example, the front portion 322 may be slidable toward the support portion to allow a relative movement of the first cutting member 30 and the control element 32 during shaving. In another example, the front portion of the control element may be fixedly or removably attached to the support portion of the cutting member, such that the first cutting member and the control element move together.

In embodiments, the rear portion 323 of the control element 32 may be a bar extending longitudinally on an edge of the control element 32 (see FIGS. 6 and 20). In other embodiments, the rear portion 323 may be in form of two or more lashes 323 extending from the central portion 321 of the control element 32 (see FIG. 19). The lashes 323 may be each in contact with the second cutting member 31, in particular with the blade portion 312 of the second cutting member 31 (see FIG. 21). All or some lashes may be attached to the cutting member. Some lashes may not be attached to the cutting member. In still other embodiments, the rear portion may be several bars arranged side by side on the longitudinal rear side of the control element. The rear portion may be of any form and number.

In some aspects, the control element may not comprise a hollow portion (or cutout, as defined previously). This may be the case when the rear portion directly extends from the central portion, e.g. in the form of at least one, ideally at least two lashes, or even three or more lashes, as depicted in FIG. 19. Herein the central portion and the rear portion may be adjacent. The second cutting member may be in contact with the rear portion of the control element such that a spacing is available along the y-y axis between the rear edge of the central portion and the cutting edge of the second cutting member. This spacing may form a skin gap. Any other form of the rear portion may be thought to provide a contact portion to the second cutting member. In other embodiments not shown, the rear portion may be a longitudinal full material portion extending partially or totally along the length of the control element in x-x axis. The rear portion may be adjacent to the central portion, and a hollow portion may not be present. To enable a good hair management during shaving, the central portion may be configured such as to comprise apertures (or recesses) as described herein. A skin gap as such may thus be reduced to a minimum, or even be equal to zero.

In some embodiments, the control element may comprise a reinforcing portion, a rear portion in form of lashes extending from the central portion and no hollow portion, as for instance depicted in FIG. 18.

In embodiments, the hollow portion 324 may be one longitudinal aperture, as shown in e.g. FIGS. 5, 6, 16, 17. In other embodiments, the hollow portion 324 may be more than one longitudinal aperture (e.g. two or more).

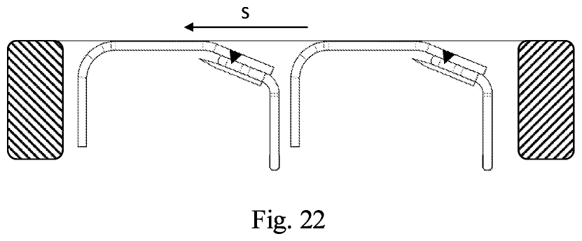

In embodiments, an additional control element as described herein may be provided for the first cutting member. The control element may be placed before the first cutting member in the shaving direction and may be in contact with the first cutting member. This may provide support to the skin in razor cartridge configurations in which the spacing between the first contact point of the razor cartridge with the skin, e.g. the guard member, and the first cutting member is large. FIG. 22 illustrates an embodiment wherein the first and the second cutting members are provided with control elements, both situated below the respective cutting member. This may provide an enhanced trimming effect during shaving.

In embodiments not shown, the razor cartridge may comprise more than two cutting members. In particular, the razor cartridge may comprise one or more additional cutting members located before and/or behind the control element and the second cutting members in the shaving direction. In some aspects, one or more (or none) of the additional cutting members may be provided with control elements as described herein.

The material of the control element may be any corrosion resistant metal such as stainless steel, aluminum, or even plastic, ceramic or other composite materials. The control element may be an integrally formed one-piece component or an assembly of single components. The control element may be precisely cut by an initial flat sheet of raw material (e.g. a sheet of metal) by various conventional methods, such as punching, laser cutting, photo-etching, and others. The final 3D shape of the control element may be realized with various forming processes, such as bending, roll forming, progressive forming or others. The control element may be a 3D printed part made of e.g. a polymer-based material. The thickness of the control element may be constant or may vary. The thickness may be in a range of 0,02 mm to 0,5 mm, in particular in a range of 0,1 mm to 0,2 mm, more particular of 0,15 mm, or 0,1 mm, or 0,28 mm.

In some aspects, in order to enhance its functionality, the control element can comprise a wound healing and/or an anti-bacterial agent and/or coating. Wound healing material components or agents can for example be hydrocolloids, hydrogels, polycaprolactone (PCL), natural polymer films (as wound dressing), bioactive dressings made from natural polymers and skin substitutes containing allogenic live fibroblasts. Anti-bacterial agents can for example be obtained using silver ion antimicrobial technology. Silver ion antimicrobial technology may be a silver-based active ingredient that can be incorporated e.g. into polymers, coatings, textiles and more to offer continuous product protection against bacterial growth. The control element can also comprise a lubricating coating, such as hydrophobic or hydrophilic, such as polyfluorocarbon, for example polytetrafluoroethylene (PTFE), or hydrogel coating. This coating may provide a reduction of the friction between the shaving cartridge and the skin. For instance, the lubricating coating as described previously may be such a coating.

In some aspects, the control element can also have color properties. For instance, different colors can be provided on the control element in order to distinguish the male or female utilization. For instance, the control element can be blue when intended to a man shaving razor, and red or pink when intended to a woman shaving razor. Any other color may be used. The control element can also be provided with a material which may have properties allowing a changing of the color after a particular number of uses. For instance, the control element can be green when never utilized and red when worn.

One example of a method of manufacturing a razor cartridge according to the present disclosure may comprise the steps of: (i) providing a razor cartridge housing, (ii) providing a first cutting member, a second cutting member and a control member, (iii) assembling the cutting member and the control member, (iv) inserting the first cutting member, the second cutting member and the control member in the razor cartridge housing such that the cutting edges of the first and the second cutting members face in the shaving direction and that at least the support portions of the cutting members are placed in the holding slots of the housing, (v) assembling the retainers on the housing to secure the cutting member(s) and/or the control element into the housing. The method of manufacturing is not limiting any may comprise more, less or different steps, depending on the configuration of the razor cartridge chosen (several ones have been described herein). During assembly of the razor cartridge, the control element may be picked up by vacuum holders and placed in the corresponding holding slots of the housing.

The control elements as described through this disclosure may be easily attached in existing razor cartridges and joined with conventional or non-conventional types of cutting members (as e.g. depicted in the Figures of the disclosure), and easily being placed within the housing of the razor cartridge and be conventionally retained by e.g. aluminum clips, retainers, plastic covers or others.

This disclosure shall not be limiting to any embodiment. Moreover, any combination of the embodiments disclosed herein may be possible.

Although the present disclosure has been described above and is defined in the attached claims, it should be understood that the disclosure may alternatively be defined in accordance with the following embodiments:

1. A razor cartridge comprising:

a first cutting member and a second cutting member disposed between a leading longitudinal side and a trailing longitudinal side of the razor cartridge in a shaving direction of the razor cartridge, wherein the second cutting member is disposed behind the first cutting member in the shaving direction, and wherein each cutting member faces in the shaving direction; and
a control element disposed between the first cutting member and the second cutting member, wherein the control element is in contact with the second cutting member.
   2. The razor cartridge according to embodiment 1, wherein the control element comprises a central portion, and/or wherein the central portion comprises a plurality of elongated apertures oriented parallel to the shaving direction.
   3. The razor cartridge according to embodiment 2, wherein the control element further comprises a front portion, wherein the front portion is situated adjacent to and before the central portion in the shaving direction.
   4. The razor cartridge according to any of embodiments 2 to 3, wherein the control element further comprises a rear portion, wherein the rear portion is situated adjacent to and behind the central portion in the shaving direction.
   5. The razor cartridge according to any of embodiments 2 to 4, wherein the control element further comprises a hollow portion situated between the central portion and the rear portion, wherein the hollow portion is elongated perpendicularly to the shaving direction.
   6. The razor cartridge according to embodiment 5, wherein the apertures of the central portion are connected with the hollow portion.
   7. The razor cartridge according to any of embodiments 3 to 6, wherein the front portion is inclined downward by an angle between 0° and 90° relative to a shaving plane.
   8. The razor cartridge according to any of embodiments 4 to 7, wherein the rear portion is inclined downward by an angle between 0° and 90° relative to the shaving plane.
   9. The razor cartridge according to any of embodiments 4 to 8, wherein the rear portion is in contact with the second cutting member.
   10. The razor cartridge according to any of the preceding embodiments, wherein each cutting member comprises a blade portion with a cutting edge, and a support portion, wherein the cutting edge faces in the shaving direction.
   11. The razor cartridge according to embodiment 10, wherein each support portion is located in a separate longitudinal holding slot of the razor cartridge.
   12. The razor cartridge according to any of embodiments 10 to 11, wherein an inter-blade span between the cutting edges of the first and the second cutting member is more than 1,5 mm, in particular in a range of 3 to 6 mm, more particular 5,2 mm.
   13. The razor cartridge according to any of embodiments 10 to 12, wherein the inclination of the rear portion corresponds to an inclination of the blade portion of the second cutting member, such that the rear portion and the blade portion are in planar contact with each other.
   14. The razor cartridge according to any of embodiments 2 to 13, wherein the central portion is parallel to the shaving plane.
   15. The razor cartridge according to any of embodiments 2 to 14, wherein the central portion is configured to be in contact with a skin of a user during shaving.
   16. The razor cartridge according to any of embodiments 10 to 15, wherein the rear portion is in contact with the cutting member on a lower side of the blade portion, such that the cutting edge of the blade portion is situated above the rear portion of the control element.
   17. The razor cartridge according to any of embodiments 10 to 15, wherein the rear portion is in contact with the cutting member on an upper side of the blade portion, such that the cutting edge of the blade portion is situated below the rear portion of the control element.
   18. The razor cartridge according to embodiment 16, wherein the control element is in contact with the second cutting member such that an exposure of the cutting edge is neutral.
   19. The razor cartridge according to embodiment 16, wherein the control element is in contact with the second cutting member such that an exposure of the cutting edge is positive.
   20. The razor cartridge according to any of embodiments 16 to 17, wherein the control element is in contact with the second cutting member such that an exposure of the cutting edge is negative.
   21. The razor cartridge according to any of the preceding embodiments, wherein the control element is fixedly attached to the second cutting member.
   22. The razor cartridge according to any of the preceding embodiments, further comprising elastic spring fingers arranged in the razor cartridge and configured to support and vertically move the cutting members and/or the control element during shaving.
   23. The razor cartridge according to embodiment 22, wherein the control element and the second cutting member are supported by at least one elastic spring finger.
   24. The razor cartridge according to any of embodiments 5 to 23, wherein the control element further comprises a reinforcing portion extending from the central portion toward the hollow portion, and wherein the reinforcing portion is bent vertically downward such as to be arranged in a separate holding slot of the razor cartridge.
   25. The razor cartridge according to any of the preceding embodiments, wherein the control element is in contact with the first cutting member.
   26. The razor cartridge according to any of the preceding embodiments, wherein the control element further comprises a wound healing and/or an antibacterial agent.
   27. The razor cartridge according to any of the preceding embodiments, wherein the control element further comprises a lubricating coating.
   28. A shaving razor assembly comprising:

a handle; and

a razor cartridge according to any of the preceding embodiments, wherein the razor cartridge is connected to the handle.

### REFERENCE NUMERALS

A angle of the blade portion
S shaving direction
SH shaving plane
IBS inter-blade span
α angle of the front portion
β angle of the rear portion
1 shaving razor assembly
10 handle
20 razor cartridge
21 housing
22 cap member
23 guard member
24 leading longitudinal side
25 trailing longitudinal side
26 retainer
27 retainer
28 elastic spring finger
29 cutting member support
30 first cutting member
31 second cutting member
32 control element
34 holding slot
35 receiving section
50 bearing member
221 lubricating strip
311 support portion
312 blade portion
313 cutting edge
321 central portion
322 front portion
323 rear portion
324 hollow portion
325 aperture
326 reinforcing element
400a, 400b skin gap

1. A razor cartridge comprising:
a first cutting member and a second cutting member disposed between a leading longitudinal side and a trailing longitudinal side of the razor cartridge in a shaving direction of the razor cartridge, wherein the second cutting member is disposed behind the first cutting member in the shaving direction, and wherein each cutting member faces in the shaving direction; and
a control element disposed between the first cutting member and the second cutting member, wherein the control element is in contact with the second cutting member.

2. The razor cartridge according to claim 1, wherein the control element comprises a central portion.

3. The razor cartridge according to claim 2, wherein the central portion comprises a plurality of elongated apertures oriented parallel to the shaving direction.

4. The razor cartridge according to claim 2, wherein the control element further comprises a front portion, wherein the front portion is situated adjacent to and before the central portion in the shaving direction, and/or wherein the front portion is inclined downward by an angle α between 0° and 90° relative to a shaving plane.

5. The razor cartridge according to claim 2, wherein the control element further comprises a rear portion, wherein the rear portion is situated adjacent to and behind the central portion in the shaving direction, and/or wherein the rear portion is inclined downward by an angle β between 0° and 90° relative to the shaving plane.

6. The razor cartridge according to claim 2, wherein the control element further comprises a hollow portion situated between the central portion and the rear portion, wherein the hollow portion is elongated perpendicularly to the shaving direction, and/or wherein the apertures of the central portion are connected with the hollow portion.

7. The razor cartridge according to claim 1, wherein each cutting member comprises a blade portion with a cutting edge, and a support portion, wherein the cutting edge faces in the shaving direction.

8. The razor cartridge according to claim 1, wherein each cutting member comprises a blade portion with a cutting edge, and a support portion, wherein each support portion is located in a separate longitudinal holding slot of the razor cartridge.

9. The razor cartridge according to claim 1, wherein an inter-blade span between the cutting edges of the first and the second cutting member is more than 1,5 mm.

10. The razor cartridge according to claim 7, wherein the rear portion is in contact with the second cutting member.

11. The razor cartridge according to claim 7, wherein the inclination of the rear portion corresponds to an inclination of the blade portion of the second cutting member, such that the rear portion and the blade portion are in planar contact with each other.

12. The razor cartridge according to claim 2, wherein the central portion is parallel to the shaving plane.

13. The razor cartridge according to claim 2, wherein the central portion is configured to be in contact with a skin of a user during shaving.

14. The razor cartridge according to claim 6, wherein the rear portion is in contact with the cutting member on a lower side of the blade portion, such that the cutting edge of the blade portion is situated above the rear portion of the control element.

15. The razor cartridge according to claim 6, wherein the rear portion is in contact with the cutting member on an upper side of the blade portion, such that the cutting edge of the blade portion is situated below the rear portion of the control element.

16. The razor cartridge according to claim 14, wherein the control element is in contact with the second cutting member such that an exposure of the cutting edge is neutral or positive.

17. The razor cartridge according to claim 14, wherein the control element is in contact with the second cutting member such that an exposure of the cutting edge is negative.

18. The razor cartridge according to claim 1, wherein the control element is fixedly attached to the second cutting member.

19. The razor cartridge according to claim 1, further comprising elastic spring fingers arranged in the razor cartridge and configured to support and vertically move the cutting members and/or the control element during shaving, and/or wherein the control element and the second cutting member are supported by at least one elastic spring finger.

20. A shaving razor assembly comprising:
a handle; and
a razor cartridge according to claim 1, wherein the razor cartridge is connected to the handle.
